(19) United States
(12) Patent Application Publication
(10) Pub. No.: US 2003/0149593 A1
(43) Pub. Date: Aug. 7, 2003

(54) Health-care system

(75) Inventors: Steven Siong Cheak Mok, Singapore (SG); Teck Keong Bong, Singapore (SG); Yew Hing Chong, Singapore (SG); Soon Teong Poh, Singapore (SG); Da Jun Toh, Singapore (SG)

Correspondence Address: IPSOLON LLP, 805 SW BROADWAY, #2740, PORTLAND, OR, 97205, US

(73) Assignee: MSC Healthcare (S) Pte. Ltd.

(21) Appl. No.: 10/067,493

(22) Filed: Feb. 4, 2002

(51) Int. Cl. G06F 17/60

(52) U.S. Cl. 705/2

(57) ABSTRACT

A health-care system comprising: a processing machine; a plurality of biosensors respectively associated with individuals, each of the biosensors being operable to gather information regarding physiological parameters of the respective individuals and relay the information to the processing machine over a network; and data links from the processing machine to respective providers of a plurality of different health-care services to allow the transmission of instructions over the network for appropriate action to be taken in response to a determination that an individual is likely to suffer from a medical condition.

THIS INVENTION relates to a health-care system, and in particular to a health-care system for reducing unnecessary hospital visits and casing the workload on health-care professionals.

At present, health-care staff located at for instance, hospitals spend a great deal of time in the carrying out of routine diagnoses and check-ups, which reduces the available time and resources that can be spent attending to individuals who genuinely require treatment as a matter of urgency.

Objects of the present invention include the minimising of unnecessary hospital visits, benefiting patients and health-care professionals alike, and the minimising of health-care professionals' time spent diagnosing patients.

Accordingly, one aspect of the present invention provides a health-care system comprising: a processing machine; a plurality of biosensors respectively associated with individuals, each of the biosensors being operable to gather information regarding physiological parameters of the respective individuals and relay the information to the processing machine over a network; and data links from the processing machine to respective providers of a plurality of different health-care services to allow the transmission of instructions over the network for appropriate action to be taken in response to a determination that an individual is likely to suffer from a medical condition.

Advantageously, the system further comprises a first terminal connected to the processing machine and operable to present information received from one or more of the biosensors to allow the determination of whether the individual associated with the one or more biosensors is likely to suffer from a medical condition.

Preferably, at least some of the data links comprise links over the network.

Conveniently, the network is the Internet.

Advantageously, the network comprises a wireless network.

Preferably, the processing machine is operable to transmit instructions to at least one health-care service in response to the receipt of information indicating that at least one of the physical parameters of an individual with which one of the biosensors is associated is outside predetermined limits.

Conveniently, the system further comprises a delivery device operable to administer automatically a dose of a substance to an individual.

Advantageously, the delivery device is controllable by the processing machine.

Preferably, the system further comprises a location tracking device associated with one of the individuals, to track the location of the individual.

Conveniently, instructions are transmitted over the network to a health-care service include the location of an individual.

Advantageously, the system further comprises a database storing medical records of at least some of the individuals.

Preferably, the processing machine is operable to update the database following the receipt of information from one of the biosensors.

Conveniently, the processing machine is operable to present at least some of the records relating to an individual along with data received from a biosensor relating to that individual.

Advantageously, the processing machine is operable to allow real-time consultation over the network between one of the individuals and a health-care expert.

Preferably, the processing machine is operable to allow at least one further party to join the real-time consultation.

Conveniently, the real-time consultation comprises video conferencing.

Advantageously, the individuals are selected from the group comprising: health-care users, out-patients, in-patients and intensive care patients.

Preferably, the system further comprises a personal data storage unit associated with one of the individuals.

Conveniently, the personal data unit is used to identify an individual to a biosensor before the biosensor gathers the information from the individual.

Advantageously, the personal data unit is used to identify an individual to a biosensor before the biosensor gathers the information from the individual.

Preferably, medical records relating to the individual are stored on the personal data storage unit.

Conveniently, the personal data storage unit allows access to a database on which medical records relating to the individual are stored.

Advantageously, tie personal data storage unit is programmed to allow access to selected portions of medical records of the individual to selected entities.

Preferably, the personal data storage unit is operable to connect to the network by a wireless connection or by a contact connection.

Conveniently, the personal data storage unit comprises a smart card

Advantageously, the system further comprises a portable processing device, wherein the personal data storage unit is operable to transfer data stored therein to the portable processing device.

Preferably, the portable processing device is operable to analyse data received from the personal data storage unit to determine whether at least one of the physical parameters of an individual with which one of the biosensors is associated is outside predetermined limits.

Conveniently, the access of the selected entities to the selected portions of the records expires after a predetermined period.

Advantageously, the health-care services are selected from the group comprising: a pharmacy, a physician, an emergency service; a medical hardware supplier; a nutritionist; a source of health-care information; a health-care related government body; a nursing care centre; a research facility; a health insurance broker; and a financial institution.

Preferably, one of the health-care services comprise a source of medical records having features selected from the group comprising bio-data, health-care records, a health-care: calendar, and a financial calendar.

Conveniently, the processing machine is operable to transmit information regarding a condition that an individual has or is likely to develop to the individual.

Advantageously, the information is relayed to the processing machine over the network in an encrypted form, the encryption being specific to the individual to whom the information relates.

Preferably, at least one of the biosensors comprises a micro array.

Conveniently, at least one of the biosensors is operable to obtain a DNA sample from an individual.

Another aspect of the present invention provides a method of monitoring the health of a plurality of individuals, the method comprising the steps of:

equipping a plurality of individuals with biosensors;

gathering information regarding physiological parameters of the respective individuals using the biosensors;

relaying the information to a processing machine over a network; and

providing data links to respective providers of a plurality of different health-care service to allow the transmission of instructions over the network for appropriate action to be taken in response to a determination that an individual is likely to suffer from a medical condition.

Advantageously, the method further comprises the step of presenting the information received from one or more of the biosensors to allow the determination of whether the individual associated with the one or more biosensors is likely to surfer from a medical condition.

Preferably, at least some of the data comprise links over the network.

Conveniently, the network is the Internet.

Advantageously, the network comprises a wireless network.

Preferably, the method further comprises the step of transmitting instructions to at least one health-care service in response to the, receipt of information indicating that at least one of the physical parameters of an individual with which one of the biosensors is associated is outside predetermined limits.

Conveniently, the method further comprises the step of providing a delivery device operable to administer automatically a dose of a substance to an individual,

Advantageously, the delivery device is controllable by the processing machine.

Preferably, the method further comprises the step of tracking the location of one of the individuals using a location tracking device associated with the individual.

Conveniently, the step of transmitting instructions over the network to a health-care service includes the step of providing the location of an individual.

Advantageously, the method further comprises the step of storing medical records of at least some of the individuals.

Preferably, the processing machine is operable to update the medical records following the receipt of information from one of the biosensors.

Conveniently, the method further comprises the step of presenting at least some of the records relating to an individual along with the presentation of data received from a biosensor relating to that individual.

Advantageously, the method further comprises the step of allowing real-time consultation over the network between one of the individuals and a health-care expert.

Preferably, the method further comprises the step of allowing at least one further party to join the real-time consultation.

Conveniently, the step of allowing real-time consultation comprises the step of allowing video conferencing.

Advantageously, the method further comprises the step of selecting the individuals from the group comprising: health-care users, out-patients, in-patients and intensive care patients.

Preferably, the method further comprises the step of providing one of the individuals with a personal data storage unit.

Conveniently, the personal data storage unit is operable to receive and store data from a biosensor.

Advantageously the method further comprises the step of identifying the individual to a biosensor, from information stored on the personal data storage unit, before the biosensor gathers the information from the individual.

Preferably, medical records relating to the individual are stored on the personal data storage unit

Conveniently, the personal data storage unit allows access to a database on which medical records relating to the individual are stored.

Advantageously, the method further comprises the step of programming the personal data storage unit to allow access to selected portions of medical records of the individual to selected entities.

Preferably, the personal data storage unit is operable to connect to the network by a wireless connection or by a contact connection.

Conveniently; the personal data storage unit comprises a smart card.

Advantageously, the method further comprises the step of providing a portable processing device, the personal data storage unit being operable to transfer data stored therein to the portable processing device.

Preferably, the portable processing device is operable to analyse data received from the personal data storage unit to determine whether at least one of the physical parameters of an individual with which one of the biosensors is associated is outside predetermined limits.

Conveniently, the access of the selected entities to the selected portions of the records expires after a predetermined period.

Advantageously, the health-care services are selected from the group comprising: a pharmacy, a physician, an emergency service; a medical hardware supplier; a nutritionist; a source of health-care information; a health-care related government body; a nursing care centre; a research facility; a health insurance broker; and a financial institution.

Preferably, one of the health-care services comprises a source of medical records having features selected from the group comprising bio-data, healthcare-records, a health-care calendar, and a financial calendar.

Conveniently, the method further comprises the step of transmitting information regarding a condition that an individual has or is likely to develop to the individual.

Advantageously, the information is relayed to the processing machine the network in an encrypted form, the encryption being specific to the individual to whom the information relates.

Preferably, at least one of the biosensors comprises a microarray.

Conveniently, at least one of the biosensors is operable to obtain a DNA sample from an individual.

In order that the present invention may be more readily understood, examples thereof will now be described, by way of example, with reference to the accompanying drawings, in which:

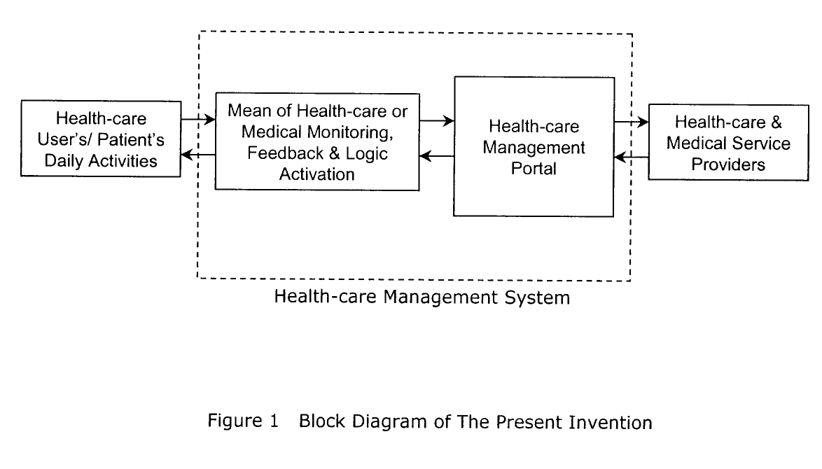

FIG. 1 shows a schematic block diagram of elements of the present invention;

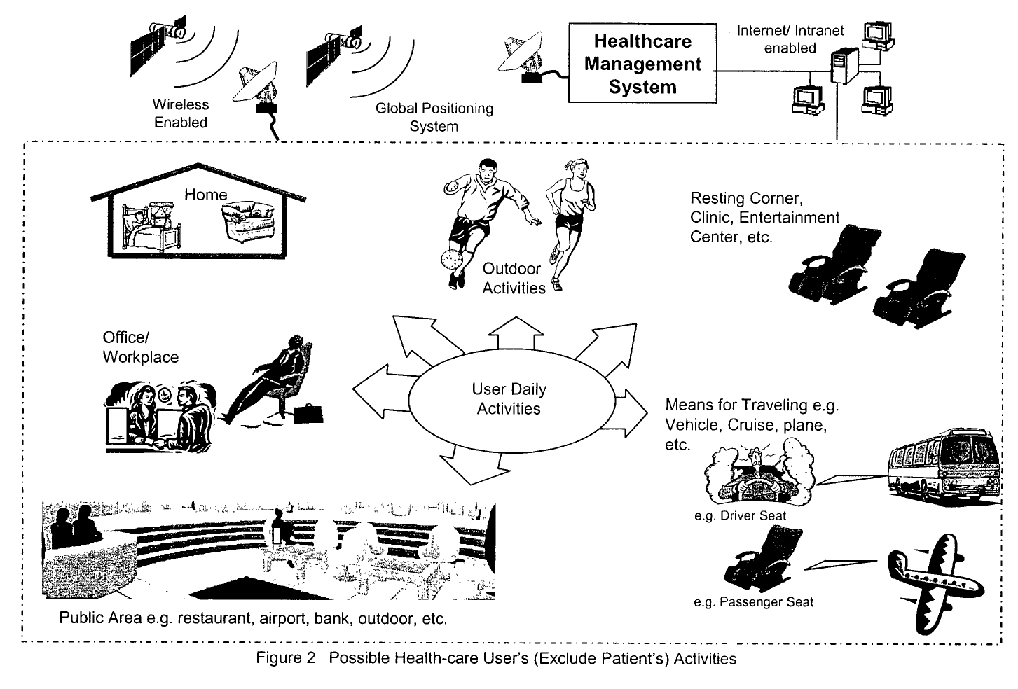

FIG. 2 shows a schematic representation of some of a health-care user's possible daily activities;

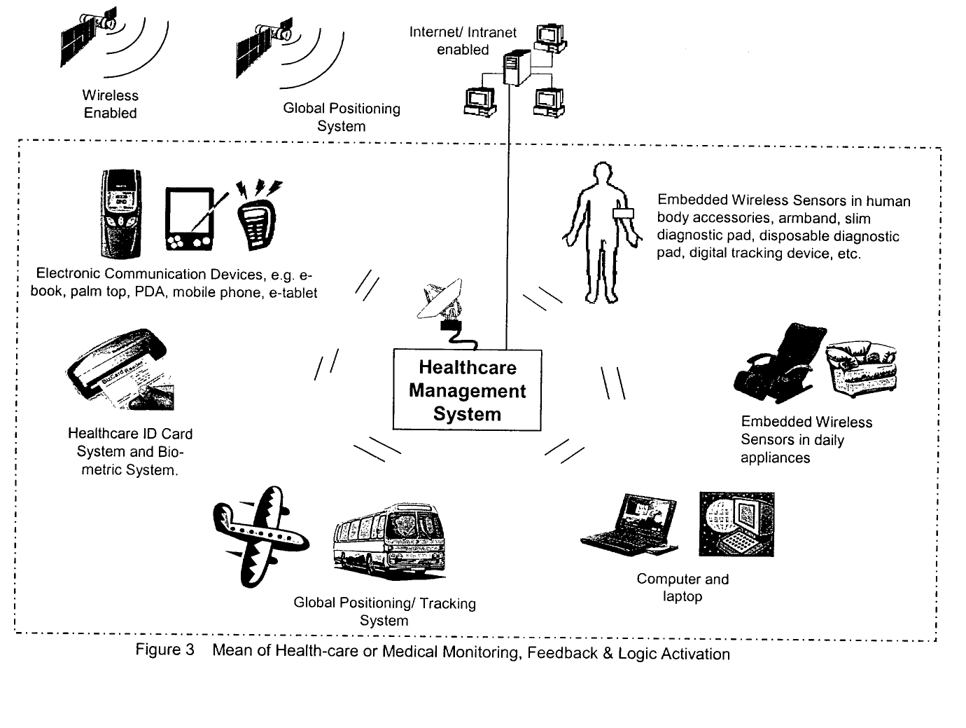

FIG. 3 shows a variety of components which allow monitoring of a health-care user in a system embodying the present invention;

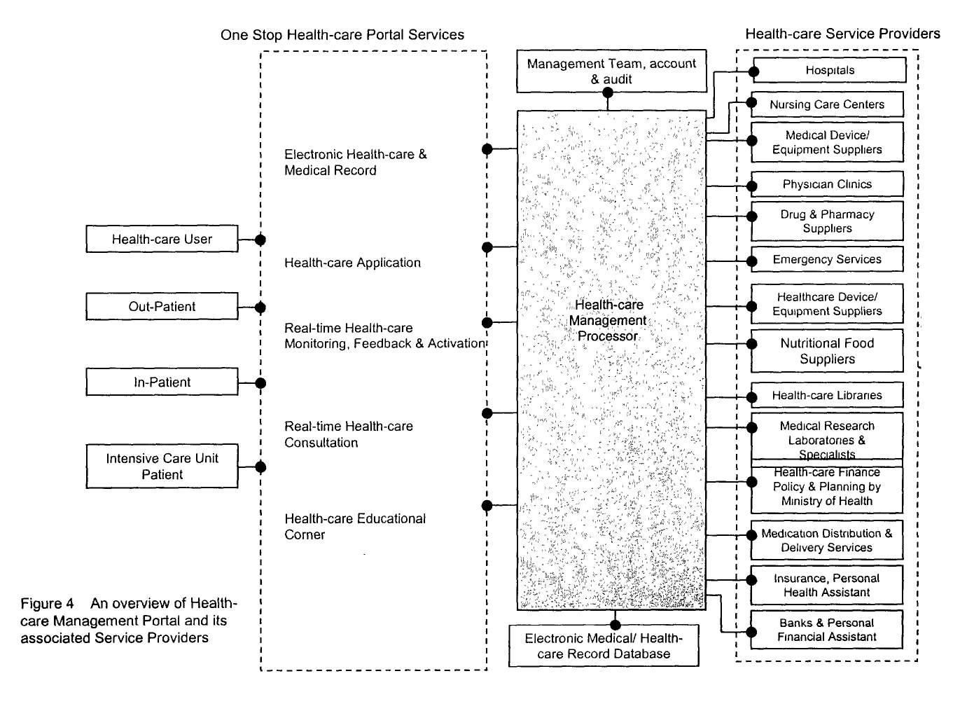

FIG. 4 shows a block diagram of a health-care management processor, along with links to associated service providers;

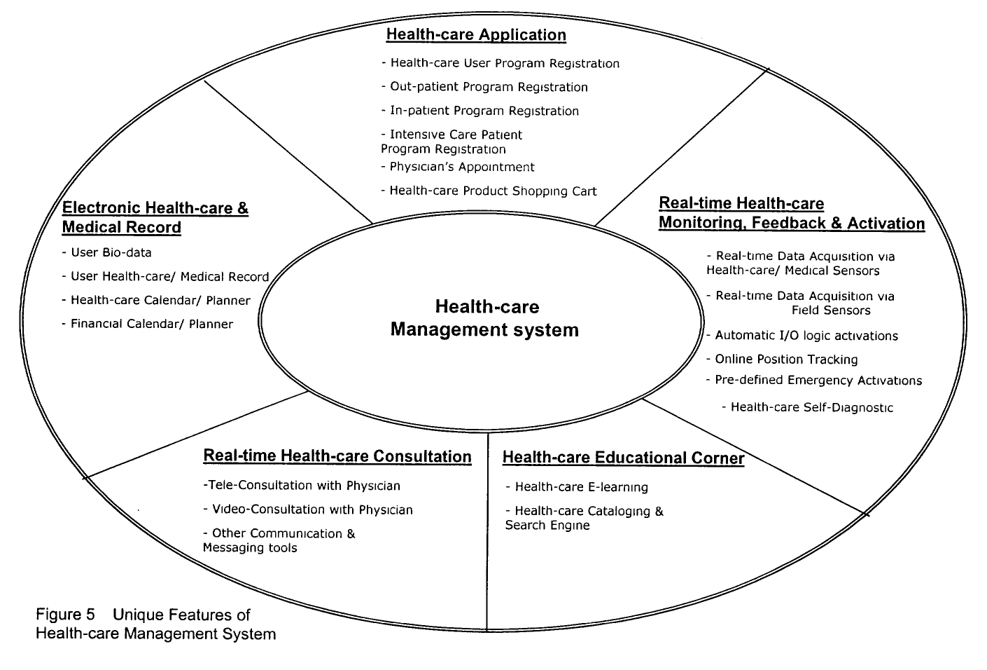

FIG. 5 show,; the main features of a system embodying the present invention;

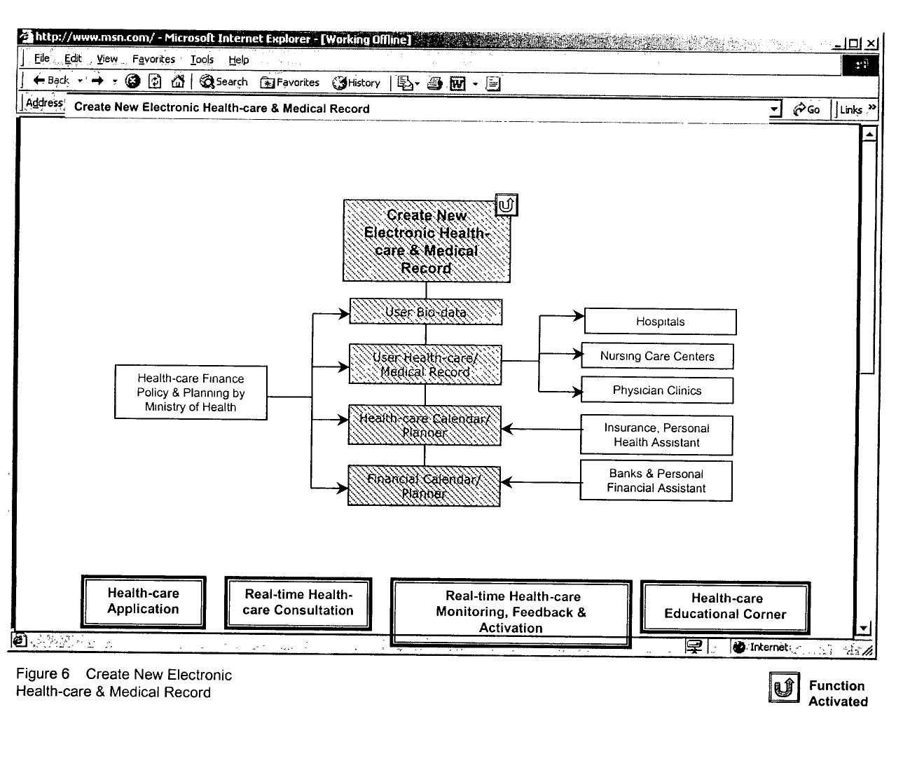

FIG. 6 shows a screen that may be seen during the creation of a new electronic record using a system embodying the present invention;

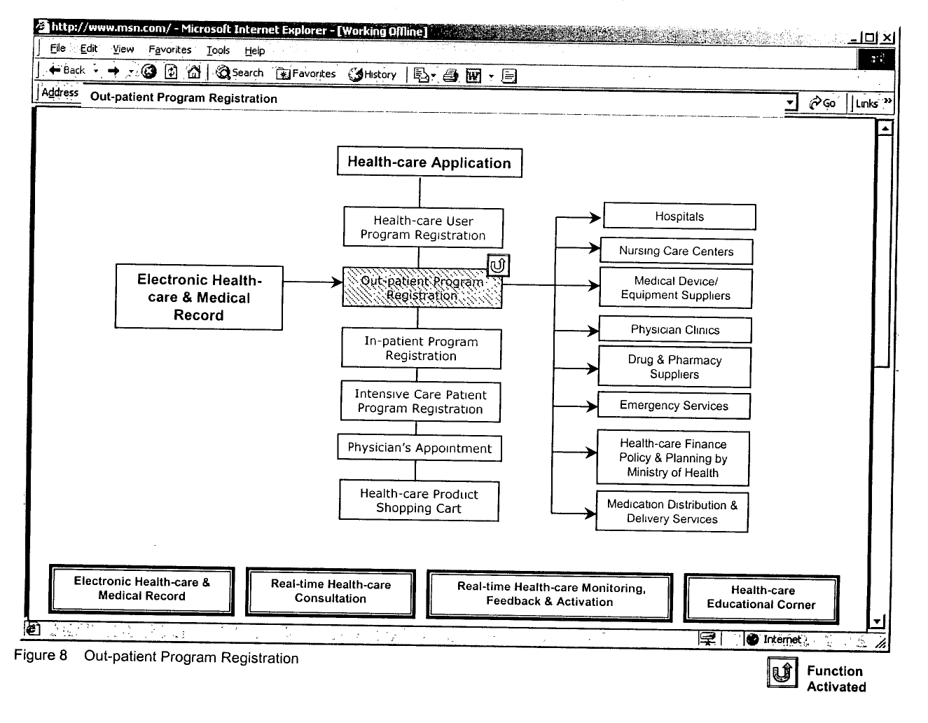

FIG. 8 shows a screen that might be seen during the registration of a out-patient using a system embodying the present invention;

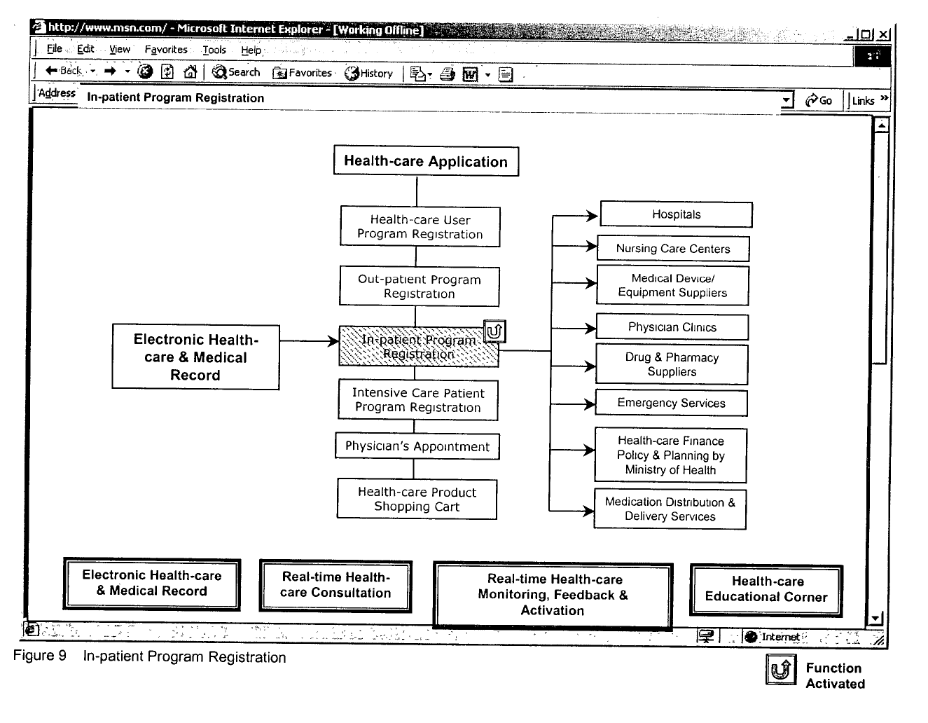

FIG. 9 shows a screen that might be seen during the registration of a an in-patient using a system embodying the present invention;

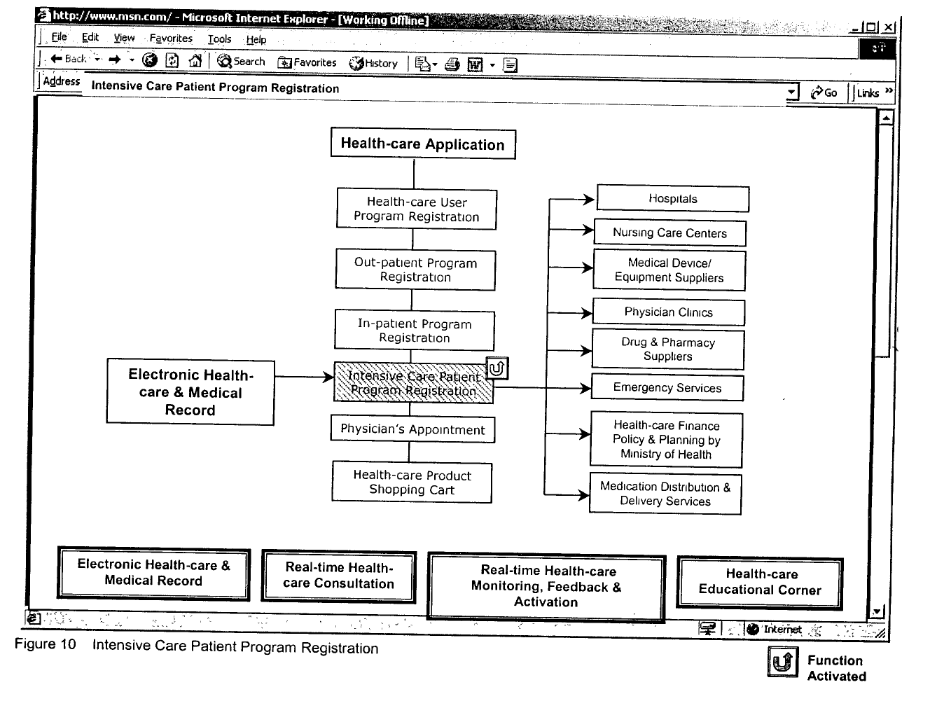

FIG. 10 shows a screen that may be seen during the registration of an intensive care patient using a system embodying the present invention;

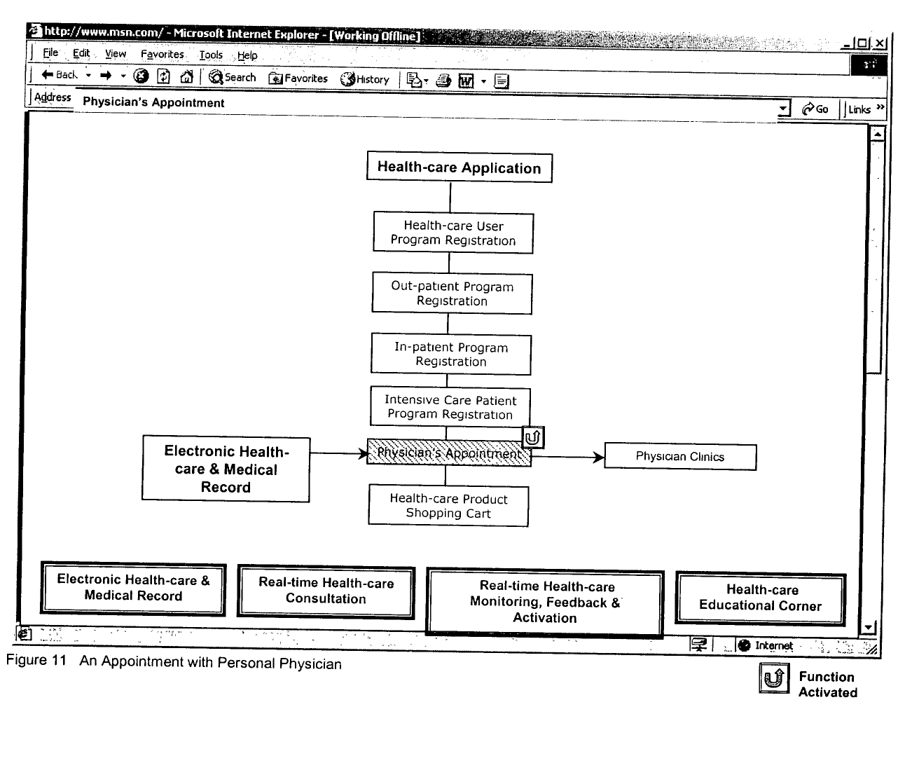

FIG. 11 shows a screen that may be seen while making a personal appointment with a physician using a system embodying the present invention;

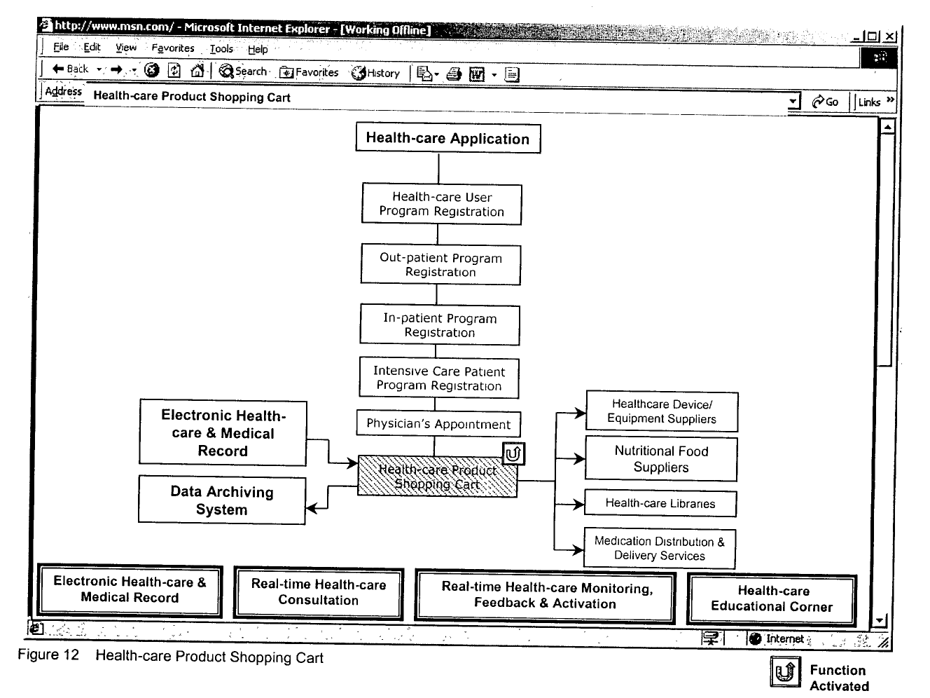

FIG. 12 shows a screen that may be seen during the purchase of health-care products using a system embodying the present invention,

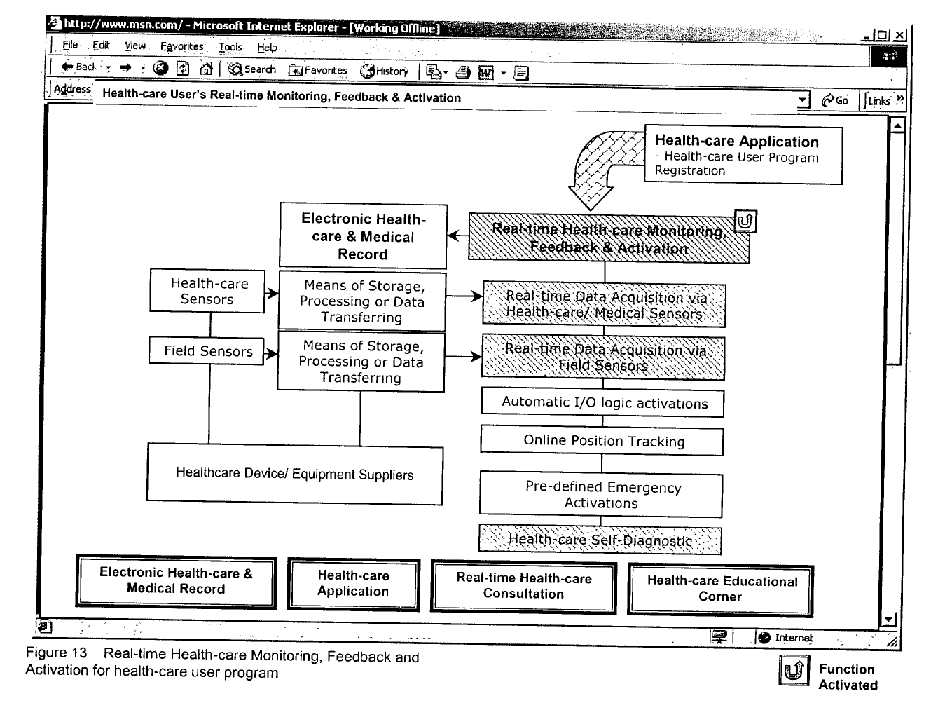

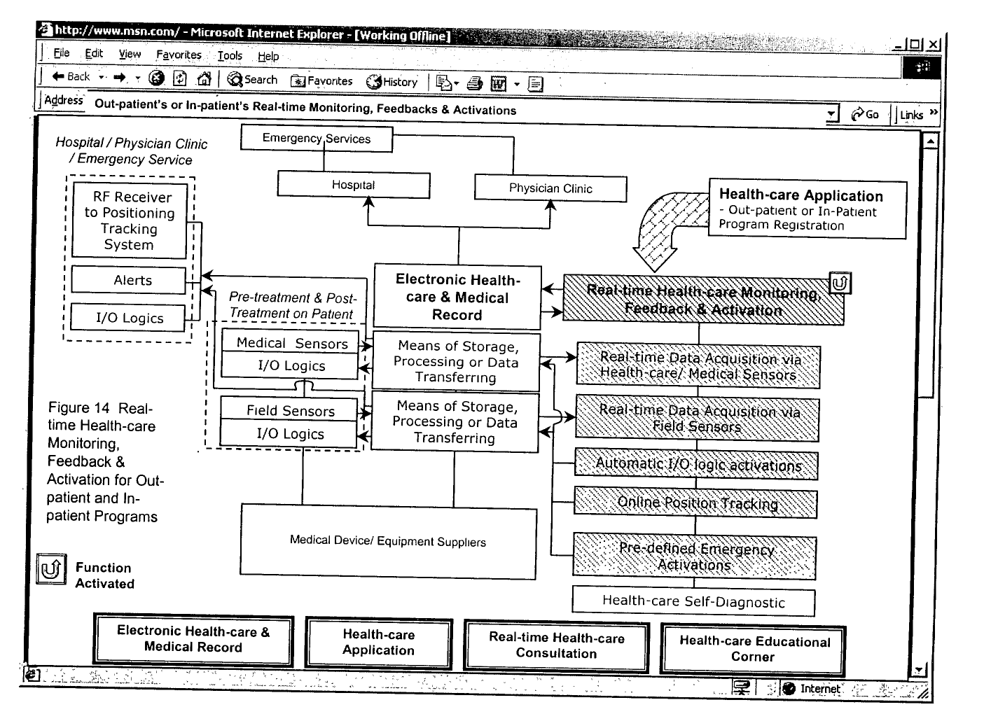

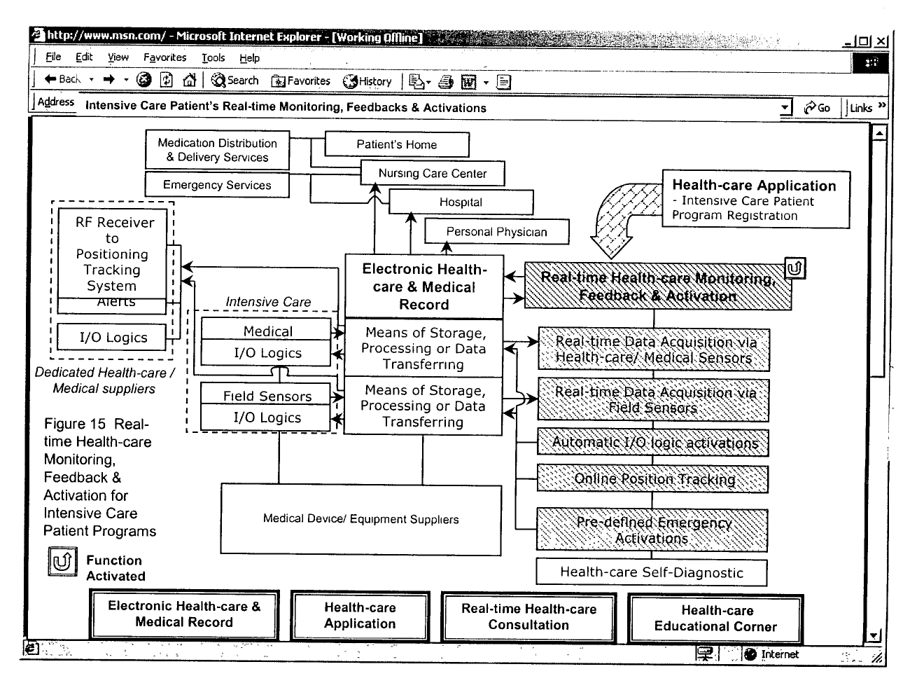

FIGS. 13 to 15 show screens that might be seen during real-time monitoring, feedback and activation using a system embodying the present invention;

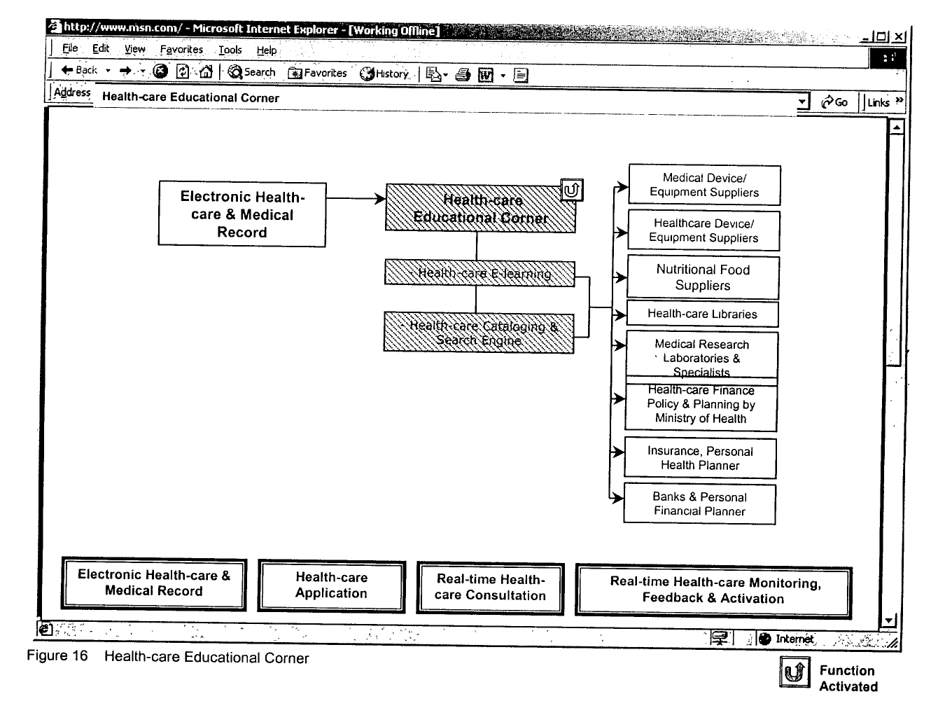

FIG. 16 shows a screen that might be seen during health-care education using a system embodying the present invention;

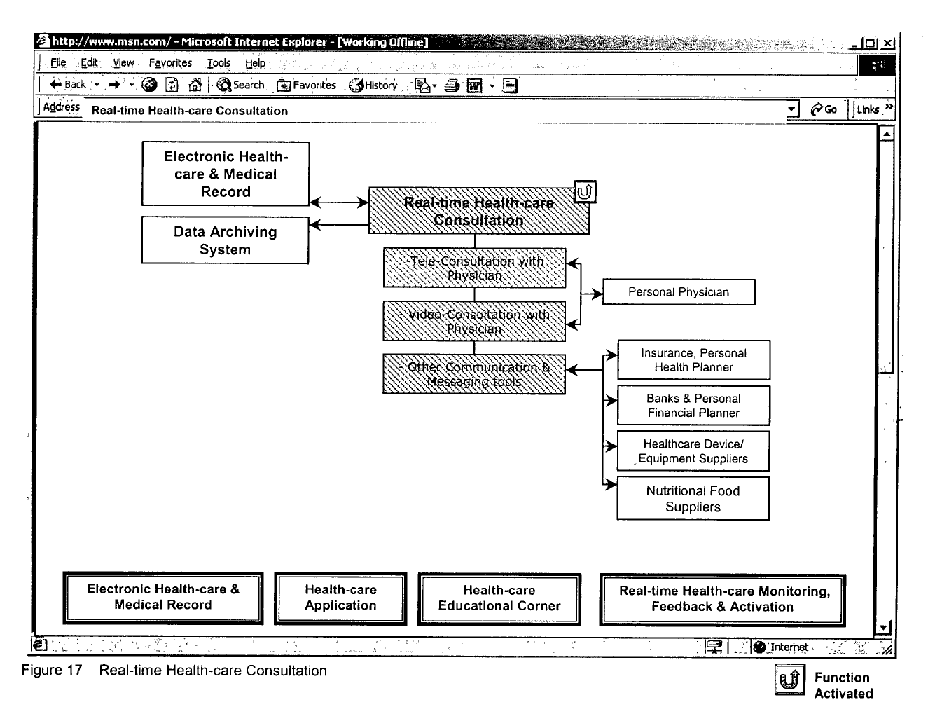

FIG. 17 shows a screen that might be seen during a real-time health-care consultation using a system embodying the present invention;

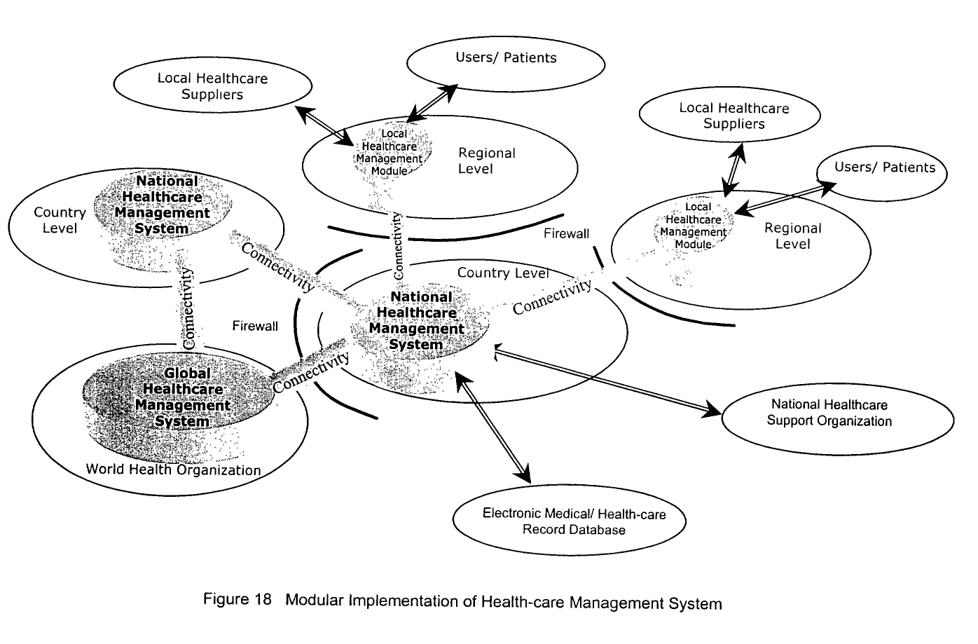

FIGS. 18 to 20 are schematic representations of systems embodying the present invention;

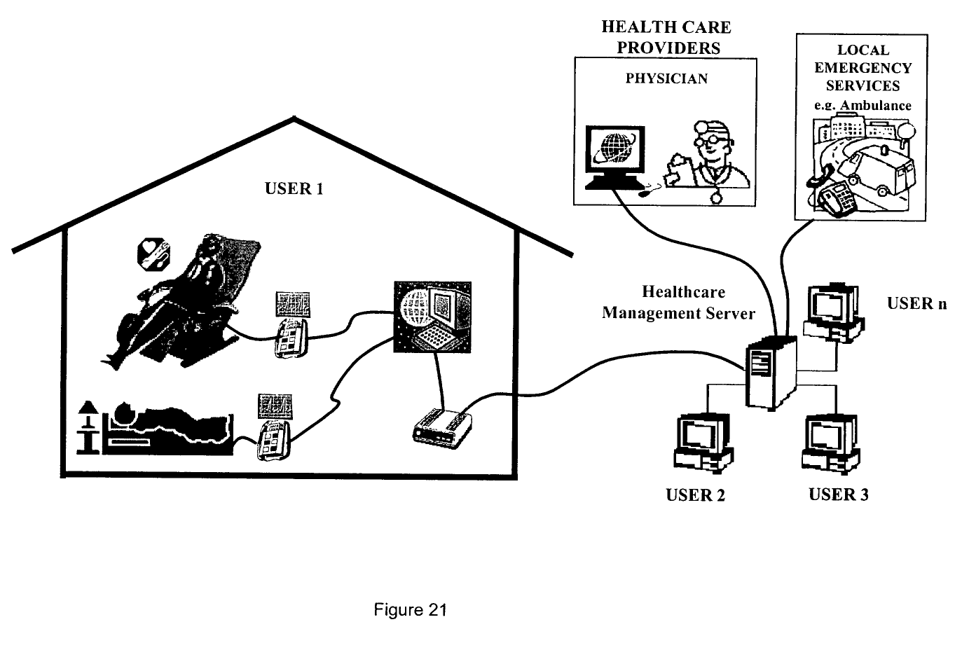

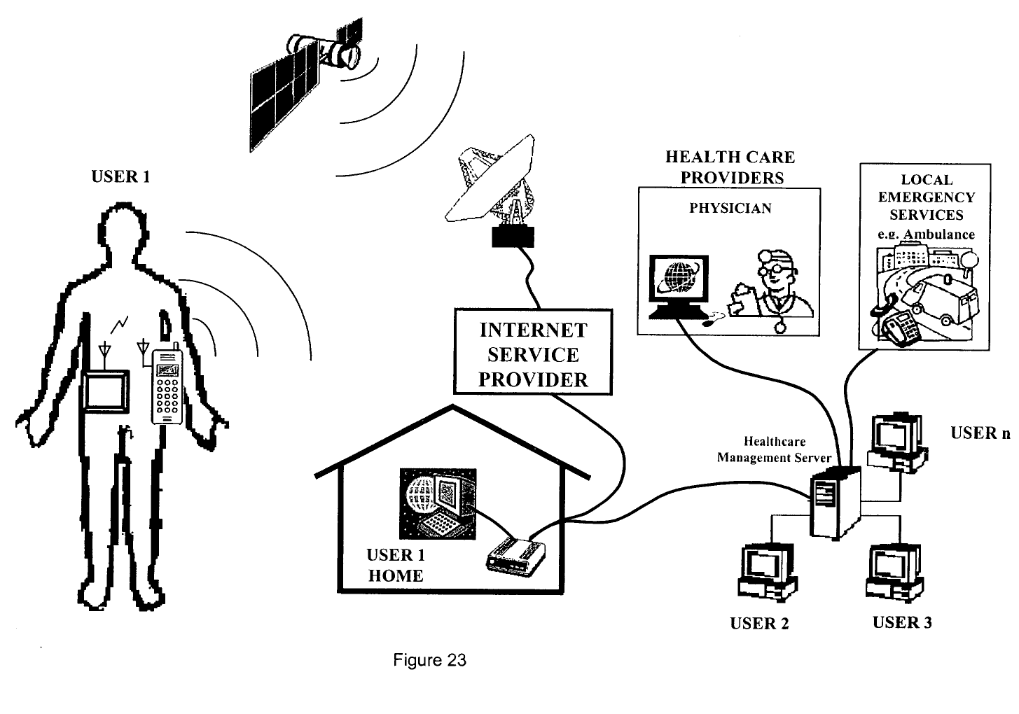

FIGS. 21 to 24 show schematic representations of physical elements of systems embodying the present invention; and

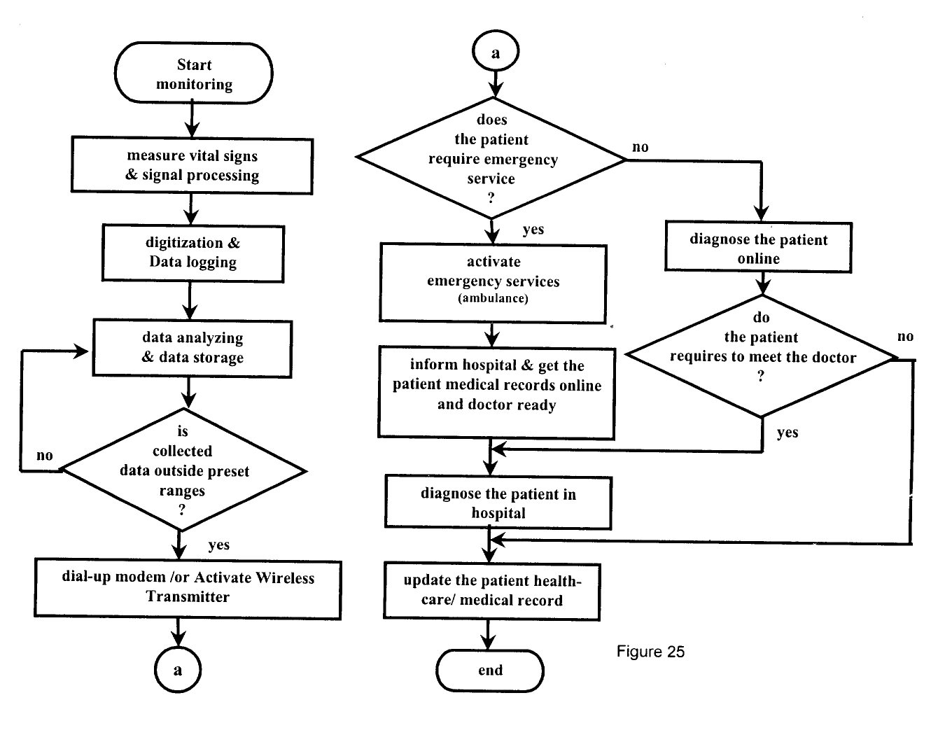

FIG. 25 shows a flow diagram indicating steps that may be taken during use of a system embodying the present invention.

Turning firstly to FIG. 1, the present invention provides a flexible link between the daily activities of a health-care user or patient, and providers of health-care or medical services.

FIG. 2 shows numerous examples of daily activity in which a health-care user or patient may be engaged. For instance, the health-care user or patient may be at home, in an office, partaking in outdoor activities or sports, resting in, for example, a clinic or an entertainment centre, travelling by any means, or may be engaged in an activity in a public area, such as a restaurant or a bank.

In embodiments of the present invention, the health-care user or patient is equipped with a biosensor. The biosensor may take a variety of forms, but the key feature thereof is that the biosensor is operable to gather information regarding physiological parameters of the health-care user or patient. For instance, the biosensor may be operable to measure the body temperature, blood pressure, pulse, blood glucose levels, blood oxygen levels and so on, A skilled person will readily appreciate how such sensing may be achieved using a small, portable biosensor.

In preferred embodiments of the present invention, the biosensor is adapted so that use thereof can be made during any of the activities outlined above in relation to FIG. 2. For instance, a health-care user or patient may wish to monitor certain of his/her physical parameters (for instance, pulse rate and blood pressure) during a sporting activity, and in this instance the biosensor may comprise embedded wireless sensors which can be provided adjacent or near the body of the health-care user or patient for instance in an arm band or slim diagnostic pad.

Alternatively, the health-care user or patient may wish to monitor certain physical parameters while relaxing at home, working in an office, whilst driving or whilst undergoing therapy (for instance, a massage). In this case, the biosensor may be built into an appliance near or on which the health-care user or patient will be located. For instance, the biosensor may be provided in the health-care user or patient's favourite chair, in a massage chair, or in the driving or passenger seat of a vehicle. In order to save time and minimise the inconvenience of measuring physical parameters using a biosensor, a health-care user or patient may wish to use a biosensor during a meal, whilst queuing, for instance, at a bank, or whilst shopping. Hence, it is preferred that the biosensor is lightweight, portable and easy to use in an unobtrusive manner. Turning to FIG. 3, various embodiments of a biosensor are illustrated.

In preferred embodiments of the present invention, a biosensor may comprise a microarray. Conventionally, a microarray comprises small spots of DNA fixed to a slide or membrane, and is used in gene expression monitoring, genetic mapping, and detection of highly multiplexed sequences. The use of microarray is, however, not limited to the study of DNA, and the benefits of rapid analysis of many events in parallel can be obtained in the study of peptides, antibodies, receptor proteins, small organic molecules, and so on. In essence, any group of fluids that can be detected on a surface and monitored for hybridisation or binding to a sample labelled with a reported molecule can be studied using a microarray.

In embodiments of the present invention, a blood or DNA sample is collected from a health-care user or patient, and this may be achieved using a disposable micro-needle. A biosensor may comprise a portable diagnostic module, which is operable to analyse the blood or DNA sample.

Any of the biosensors which may be used with the present invention may be integrated or otherwise used with a personal digital assistant (PDA), so that the PDA may receive and store data from the biosensor. The connection between a biosensor and a PDA may be wireless, or maybe a contact connection. In preferred embodiments of the present invention, a health-care user or patient's PDA may be operable to perform a degree of automatic diagnosis, based upon information received from one or more biosensors.

Data collected by the biosensor regarding physical parameters of the health-care user or patient is transmittable to a central server, and the functions of this central server will be discussed in greater detail below, However, in general, the central server will be located at a relatively large distance from a health-care user or patient using a biosensor as described above. Indeed, the central server may cater for a large number of health-care users or patients distributed over a wide geographical area.

There are several ways in which data collected by a biosensor may be transmitted to the central server. For instance, the home of a health-care user or patient may be equipped with a personal computer, palm-top computer or the like, which has a connection to the Internet. Data gathered by a biosensor may be transmitted to the personal computer, by a wireless link or cable, and may subsequently be transmitted to the central server across the Internet.

In the case of a biosensor that is located within, for instance, the chair of a health-care user or patient, the biosensor may be equipped with a permanent link to the health-care user or patient's personal computer, or may be positioned so that an infra-red data connection can be established with the personal computer at any time.

In another embodiment, a biosensor may be provided with a link to a health-care user or patient's mobile telephone, and again this link may take the form of wireless transmission or a cable. Data collected by the biosensor and transmitted to the mobile telephone may then be transmitted by the mobile telephone to a base station, using the normal data transmission capabilities of the mobile telephone. Once the information transmitted by the mobile telephone is received by a base station, this information can be transmitted onwardly to the central server, and this may be achieved, for instance, by further transmission among base stations or through a connection of the original base station to the Internet.

In an advantageous embodiment of the present invention, a health-care user or patient may also be provided with a location tracking device, such as a GPS device. The utility of this will be discussed below.

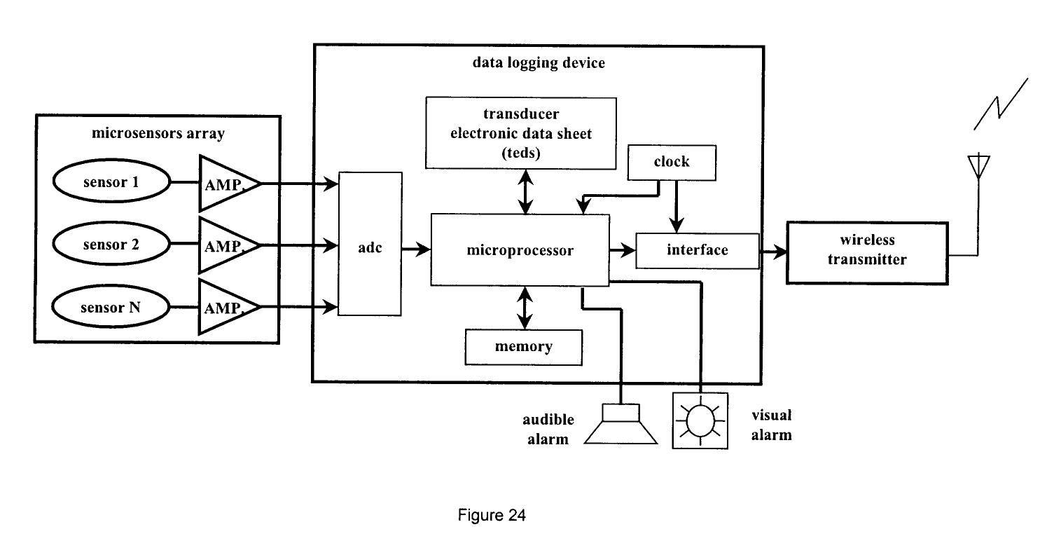

Turning to FIGS. 21 to 23, various systems which allow the transmission of data gathered by a biosensor are depicted. FIG. 24 shows an embodiment of a device operable to transmit data from the biosensor. The device receives and amplifies analogue information from three sensors, and this information is converted into digital signals by an analogue to digital converter (ADC). The digital information is converted into a form suitable for transmission and then transmitted, or may be stored in a memory of the device.

The device is also equipped with visible and audible alarms, which may be activated if information which appears to relate to a serious medical condition is received from the sensors.

It is envisaged that users of biosensors in accordance with the present invention will fall into three major categories.

Firstly, a health-care user or patient may suffer from a chronic disease, or may be elderly, and hence will require regular and frequent monitoring of appropriate physical parameters. Hence, such health-care users or patients will incorporate the use of one or more biosensors as described above into their normal routine, and transmission of data collected by the biosensors will be regularly transmitted to the central server. The embodiments described above in which biosensors are incorporated into, for instance, a chair in the home of the health-care user or patient are particularly appropriate for this first category of user, since physical parameters of the health-care user or patient's body can be routinely monitored while, for instance, the health-care user or patient watches a television programme, or is asleep. In this case, the biosensors may be connected to a personal computer of the health-care user or patient, which is configured to log on to the Internet automatically at a predetermined interval and transmit data collected by the biosensors to the central server.

A second category of health-care user or patient contains those who are in good health, but believe that prevention is better than cure, and are keen to maintain good health while being alerted to any potential health problem at an early stage. This category of health-care user is likely to wish to monitor their physical parameters less frequently than those in the first category, but this monitoring will still be conducted on a regular basis, and again the incorporation of biosensors into the chair of the health-care user would be appropriate.

While the physical parameters of the first category of health-care users or patients that are measured will generally be directed to existing conditions from which the health-care user or patient suffers, it is likely that a wider range of physical parameters of the second category of health-care user will need to be measured. This is simply because, since the second category of health-care users are already in good health, the health-care monitoring is unlikely to be directed to the diagnosis of a specific condition, but rather to the early diagnosis of a wide range of possible conditions, and clearly the greater the number of physical parameters of the health-care user that can be measured, the greater the number of conditions that can be pre-emptively diagnosed.

A third category of health-care user or patient contains those who are in good health, but wish to make use of biosensors as and when they feel that they have become ill. Hence, the biosensors will not be used on such a regular basis as in the case of the first two categories of potential health-care users.

The central server is adapted to present information received thereby from any of the biosensors, and this presentation may, for instance, take place on the monitor of a personal computer or laptop. In preferred embodiments of the present invention, the central server is located in a dedicated support centre, and the presentation of information received by biosensors is to a health-care expert, who will be a suitably qualified individual, and who will be able to analyse the data in an appropriate manner. Returning to the case of the fist category of health-care user or patient, the information received from the health-care user or patient's biosensor will be analysed by the health-care expert with a view to maintaining a check on the pre-existing condition of the health-care user or patient. In the case of the second category of health-care user or patient, the information received from the health-care user or patient's biosensors will be reviewed with a view to forming an early diagnosis of any potential health problem that the health-care user or patient may be developing.

Alternatively, or in addition to the analysis of data gathered by biosensors by the central server, the gathered data may have some analysis performed thereon in situ. This in situ analysis may be performed by the health-car user or patient's personal computer, or by another device such as a PDA. An alarm may be raised, or medical advice given, if the in situ analysis appears to reveal that the health-care user or patient suffers, or is likely to suffer, from a medical condition.

The frequency with which the data is reviewed in either of these cases may depend upon the seriousness of any pre-existing condition, the age of the health-care user or patient or any other relevant factors.

In the case of the third category of health-care user or patient, data transmitted from the health-care user or patients' biosensors will be reviewed by the health-care expert with a view to performing a specific diagnosis of the reason why the health-care user or patient is feeling unwell. In addition to the data collected by the biosensors, the health-care user or patient may additionally transmit data explaining any symptoms which they have, and it is envisaged that this facility will be particularly useful in the case of the third category of health-care user or patient. In this case, the health-care user or patient may transmit, along with the biosensor data, details of his or her symptoms, how long the symptoms have persisted for, and any medication that the health-care user or patient may have already taken.

Alternatively, the health-care user or patient may establish a communication link, for instance a video conferencing link, with the health-care expert. In this case, the health-care user or patient will be able to explain his or her symptoms verbally to the health-care expert, which explanation can be considered in combination with the data received from the health-care user or patient's biosensors.

This communication link is preferably established through the central server, and may, for instance, involve the use of dedicated software on a personal computer, laptop etc. of the health-care user or patient.

A fourth category of user of the system of the present invention comprises intensive care patients, who will use the biosensors within a medical institution such as a hospital.

The health-care expert preferably views the information received from health-care user or patients' biosensors at a computer terminal which is connected to the central server. The computer terminal is preferably operable to transmit instructions to a plurality of different health-care services, as will be explained in greater detail below.

For instance, if the health-care expert determines that the health-care user or patient is in need of a specific type of medication, then the health-care expert may transmit an instruction to a pharmacy to prepare the necessary medication and arrange for the delivery thereof to the health-care user or patient, or for collection thereof by the health-care user or patient.

If the health-care expert determines that the healthcare user or patient requires treatment or further diagnosis by a physician, then the health-care expert may access a list suitable physicians in the vicinity of the health-care user or patient, to select a physician for the health-care user or patient to meet with. The health-care expert may have access to information relating to, for example, the qualifications of the physician, or the length of time for which the health-care user or patients is likely to have to wait, in order to assist the health-care expert in selecting an appropriate physician.

The health-care expert may also, through the computer terminal, contact the selected physician to check availability thereof and make an appointment on behalf of the health-care user or patient, and may transmit details of the appointment back to the health-care user or patient.

In some circumstances, the health-care expert may determine that the condition of the health-care user or patient is sufficiently serious to warrant immediate attention, arid in this case the health-care expert may summon the emergency services to fetch the health-care user or patient and deliver him or her to an appropriate hospital.

If a health-care user or patient is admitted to hospital, biosensors may be attached to the health-care user or patient while queuing or waiting to be seen by a nurse or doctor. These biosensors can gather data relating to physical parameters of the health-care user or patient, and this data can then be used by the nurse or doctor to assist in the swift and accurate diagnosis of any medical condition that the health-care user or patient may have.

The above-described embodiment in which health-care user or patent is equipped with a location tracking device, such as a GPS device, would be particularly useful if the health-care expert determines that a health-care user or patient is in a condition that warrants attention by emergency services.

The health-care expert may consider that the health-care user or patient requires a further item of hardware (for instance, a further biosensor), and may, through the computer terminal, order an appropriate item of hardware from a suitable supplier, to be delivered to the health-care user or patient or collected thereby.

Based upon the information collected by a biosensor, possibly in combination with a health-care user or patient's own description of his or her symptoms, the health-care expert may reach the conclusion that the health-care user or patient requires vitamins or an alternative nutritional supplement. In this case, the health-care expert may, through the computer terminal, contact an appropriate nutritional food supplier and instruct the delivery of an appropriate dietary supplement to the health-care user or patient, or arrange for the collection thereof by the health-care user or patient.

Further facilities may be available through the health-care expert's computer terminal may relate to one or more health-care libraries. The health-care expert can direct the health-care user or patient to a suitable library where he or she may learn more about a condition that he or she has or is likely to develop. Alternatively, the health-care expert may arrange for one or more appropriate books to be delivered to the health-care user or patient, or information regarding a condition may be sent to the health-care user or patient via e-mail.

The health-care expert may also have access to medical research laboratories and other specialists, to maintain up to date information on conditions and their treatment. Also the computer terminal may have access to information published by the relevant government body, to maintain up to date records of appropriate government legislation and guidelines.

In preferred embodiments of the present invention, the health-care expert also has access to medical records of each health-care user or patient, and may view these records via the computer terminal. Clearly, it is important for the medical records of a health-care user or patient to be available to the health-care expert if a correct diagnosis is to be made. This information will also contain details of current medication, previous illnesses, allergies and so forth, and will enable the health-care expert to make a speedy and appropriate diagnosis taking into account all relevant facts.

FIG. 4 is a schematic representation of some links which the central server (labelled as a health-care management processor) may have, and it can be seen that the above-described health-care services, along with others, are accessible therethrough. Other links shown in FIG. 4 will be described in greater detail below.

The storing of medical records in association with the central server entails a responsibility not to disclose these confidential records to unauthorised parties. Hence, in preferred embodiments of the present invention, the central server is configured so that only entities with suitable authorisation may access medical records. Advantageously, health-care professionals who are involved in the treatment of an individual health-care user or patient may be authorised to access the health-care user or patient's medical records, or selected portions thereof, for a limited time. Once the health-care professional's involvement in tie treatment of the health-care user or patient is complete, access to the medical records of the health-care user or patient will be removed.

Embodiments of the present invention provide a personal data storage unit, such as a smart card, which is associated with an individual health-care user or patient and may be carried by the health-care user or patient at all times.

Typically, a smart card is able to store only a small quantity of data, and in embodiments of the present invention a health-care user or patients' smart card stores only essential medical information, such as an identification number, a blood group, a date of birth and one or more simple keywords representing allergies. Advantageously, the smart card may also be used to access complete medical records relating to the health-care user or patient which are stored in a remote database.

Alternative personal data storage units may have significantly larger data storage capacities. For instance, a health-care user or patient may have a “memory stick” as manufactured by Sony, and it is likely that the health-care user or patient will be able to store his or her complete medical records on such a device.

It is envisaged that both contact-readable personal data storage units and personal data storage units that may be read in a contactless manner may be employed with the present invention. In preferred embodiments, data may be read directly from a health-care user or patient's personal data storage unit by a PDA or other electronic device used by emergency services personnel. It is envisaged that this facility would be particularly useful during the response to an accident involving the health-care user or patient.

In embodiments of the present invention, a health-care user or patient identifies himself to a biosensor using his or her personal data storage unit. Firstly, the personal data storage unit is brought into communication with the biosensor. This may, for example, take the form of swiping a smart card over the surface of a bio-sensing arm band, but it will be appreciated that there are many ways in which the various types of personal data storage unit may establish communication with a biosensor.

Once the health-care user or patient has been positively identified by the biosensor, the biosensor proceeds to gather data relating to physical parameters of the health-care user or patient. The gathering of physiological parameters can also take place in parallel with the identification of the health-care user or patient. In any event, the system gathers two sets of data: the physiological parameters; and the ID number of the health-care user or patient. This data (the ID number and the physiological parameters) is encrypted into a data packet which is transmitted directly to the central server via the Internet or an alternative network, Ill preferred embodiments of the invention the encryption applied to the data is specific to the individual health-care user or patient. Further, in another variation, the physiological parameters which are collected by the biosensors are determined by the ID no. of the health-care user so that, for example, a cancer patient has cancer-indicative physiological parameters gathered whereas an “ordinary” patient simply has temperature and blood pressure monitored.

In recent years, people have been less likely to visit the same medical practitioner for all of their health-care needs. Visiting several different health-care professionals can lead to fragmented and incomplete medical records, with no single location maintaining a record of all health-care information relating to the individual health-care user or patient.

However, if the health-care user or patient carries a smart card, all health-care information relating to that individual may be stored on the smart card, no matter how many different health-care professionals the individual has visited. If the smart card allows access to a remote database on which a complete health-care record of an individual are stored, the card may be operable to store any new information that is to be added to the individual's health-care record until this information can be transmitted to the remote database and added to the main body of the records. Preferably, new information is simply added to existing health-care records, rather than modifying or over-writing the remote database.

In preferred embodiments of the present invention, a health-care user or patient's personal data storage unit may be connected to a computer, and information transmitted between the personal data storage unit and a remote database on which a complete medical record of the health-care user or patient is stored. As mentioned above, such connection can be a physical contact between the personal data storage unit and the computer (in the case of a smart card), or alternatively may be a wireless connection.

The carrying of a personal data storage unit containing, or allowing access to complete medical records may be potentially life saving in the event of an accident. If an individual is incapacitated or unconscious following an accident or other medical emergency, emergency services or doctors who treat the individual may do so without knowledge of au allergy or existing condition, with potentially fatal consequences. However, if the individual is carrying a personal data storage unit which allows the emergency services or doctors to gain rapid access to the individual's complete medical records, the probabilities of inappropriate treatment or incorrect medication being administered are greatly reduced.

A personal data storage unit may also help to reduce the possibility of fraudulent insurance claims, as well as the collection of drugs from pharmacists without the issue of a correct prescription. With regard to insurance claims, insurers may require access to records via a personal data storage unit to ensure that details of treatments and so forth have not been falsified. With regard to prescribed drugs, a physician who prescribes a drug may place details of the prescription on a personal data storage unit. On arrival at a pharmacist, the individual may be required to produce his or her personal data storage unit, and details of the prescription will be taken directly from the personal data storage unit with this prescription data being deleted after the prescription has been provided. The pharmacist's premises will be equipped with a suitable reading means for extracting data from, and writing data to, the personal data storage unit, and will be provided with a suitable connection to the Internet. Hence, the collection of drugs which have not been prescribed, or the collection of a prescribed drug more than once, will be unlikely to occur.

A personal data storage unit can be programmed to allow selective access to certain entities. For instance, in the example of a pharmacist preparing a prescription drug, the personal data storage unit of the patient may be programmed so that the pharmacist is able to view only information relating to the prescriptions that the patient has or has recently had, and to no other information.

A personal data storage unit can also be used to store information as vaccinations that a user has received, along with the durations thereof or any special dietary requirements that an individual may have.

Aspects of the present invention provides software which is operable to allow the central server to carry out the required functions. FIG. 5 is a schematic representation of the five main functions that a computer program embodying the present invention may fulfil.

One major function is the maintaining of health-care records, which preferably involves the registration of different types of patient (e.g. in-patients, out-patients), the keeping of records of appointments with physicians, and so forth.

A further function, as discussed above, relates to monitoring of physical parameters of health-care users or patients. The computer program is preferably operable to interpret data received from biosensors associated with individual health-care users or patients, and present this data to a health-care expert when appropriate.

In embodiments of the present invention, the computer program is configured to perform a level of automatic diagnosis relating to data received from biosensors associated with health-care users or patients. For instance, in extreme circumstances, such as the cessation of the pulse of a health-care user or patient, or the dropping of the blood pressure thereof below a predetermined limit (which limit may depend on the individual health-care user or patient), the computer program may automatically summon the emergency services to attend to the health-care user or patient.

Also, the computer program may be configured to detect when information received from a biosensor warrants the immediate attention of a health-care expert, and may immediately present this information to a health-care expert for review.

As discussed above, a further function of the computer program relates to education of health-care users or patients, particularly regarding conditions that a health-care user or patient has or is likely to develop.

A further function relates to real-time consultation between a health-care user or patient and a health-care expert, and as discussed above this may take the form of video conferencing. The computer program is preferably operable to set up and maintain such real-time consultation, and may present the health-care expert with information relating to the health-care user or patient in question during the consultation. This information may comprise the health-care user or patient's medical records, or recently-received data from a biosensor associated with the health-care user or patient.

In advantageous embodiments of the present invention, further parties may be included in and be able to participate in a real-time consultation. In many cases, an appointment will need to be made to hold a real-time consultation with one or more health-care experts, and a health-care user or patient's personal digital assistant or mobile telephone may be configured to raise an alarm when an appointment is due, or will shortly be due, to occur.

Another function relates to the maintenance of health-care records relating to each health-care user or patient. As well as records of past medical conditions, treatments, operations and so forth, the records maintained by the computer program or an associated database may include health-care calendars or planners, or financial calendars or planners, which may be tailored to the needs of each individual health-care user or patient.

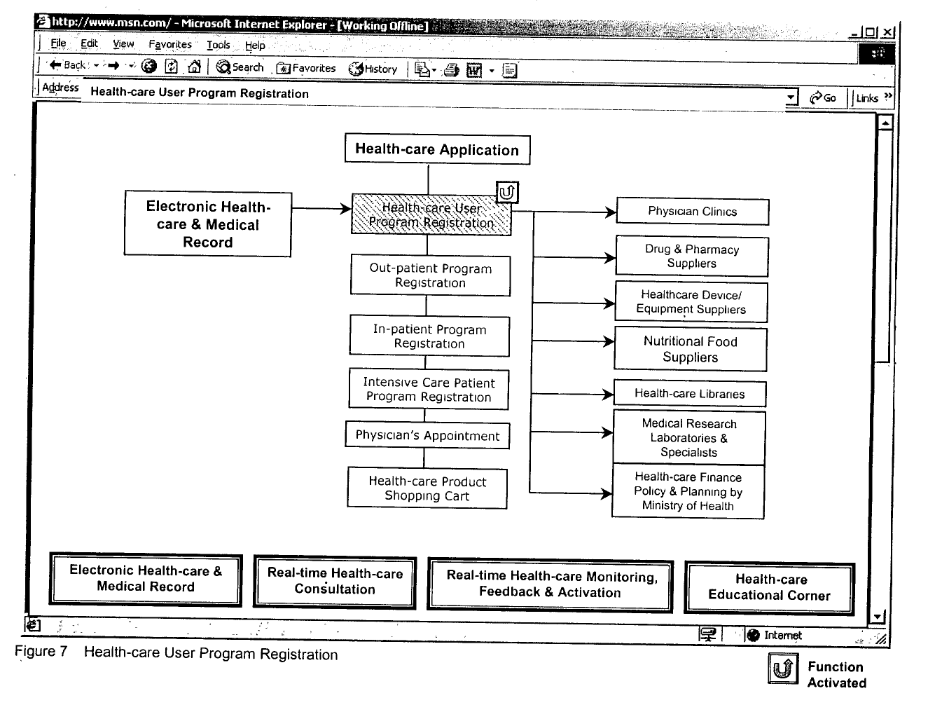

FIGS. 6 to 17 show displays that may be seen by entities using a computer program embodying the present invention, while the program is running on a central server or associated computer, as certain tasks are performed. In FIGS. 6 to 17, these tasks are: the creation of a new electronic record; the registration of a out-patient; the registration of a an in-patient; the registration of an intensive care patient; the making of a personal appointment with a physician, the purchase of health-care products; real-time monitoring, feedback and activation; health-care education; and the conducting of a real-time health-care consultation, respectively.

Turning to FIG. 18, a schematic representation of a modular implementation of the present invention is shown. In this embodiment, a single central server regulates the flow of information within a defined area, which may be as large as a country or group of countries. A number of regional servers are also provided, which provide a link between health-care users or patients and health-care services in a particular sub-region of the defined area.

The central server is also connected to one or more other central servers, which regulate the flow of information within other countries. The central server may additionally be provided with a link to a global health organisation. Firewalls may be provided where necessary, to safeguard the confidentiality of medical information and records that may be transferred between the various entities in the modular implementation. Preferably, such transfers occur across the Internet.

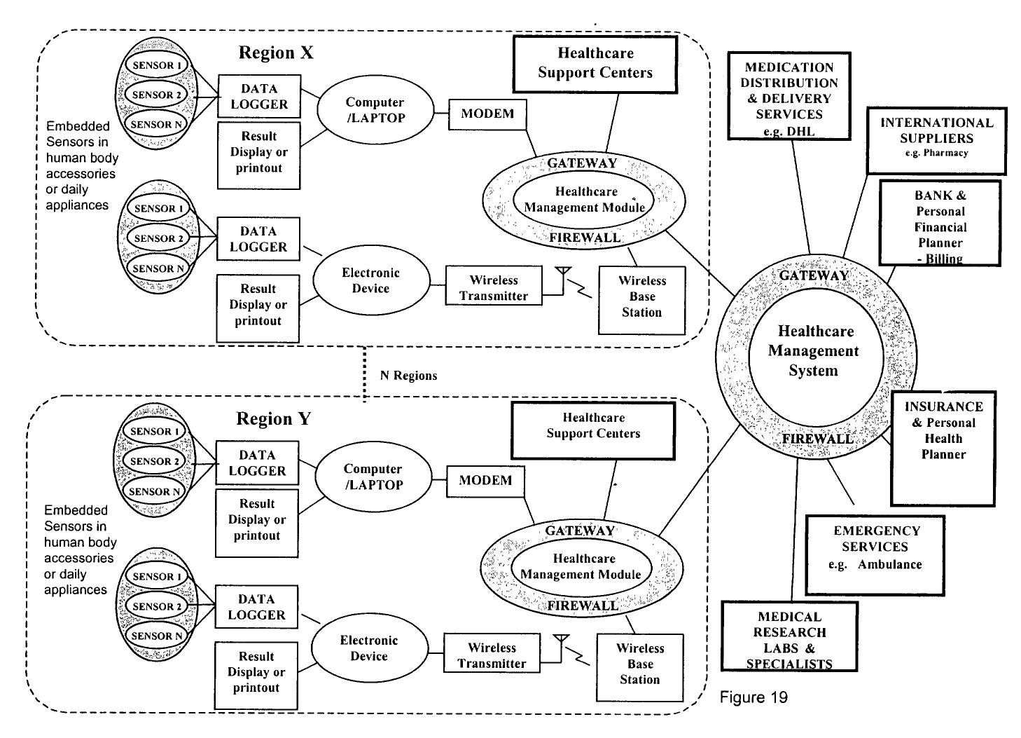

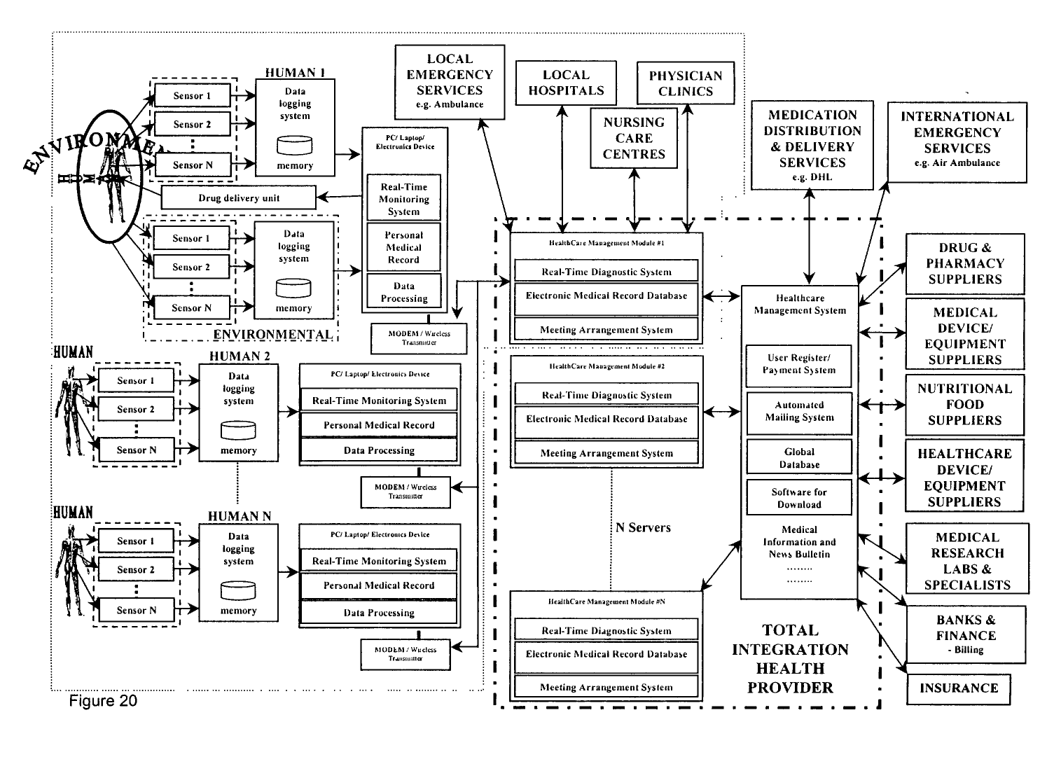

Turning to FIGS. 19 and 20, a global server is depicted (labeled as a healthcare management system and a total integration health provider respectively in these Figures), which oversees the flow of information among all of the central servers which are dedicates to the various defined areas. The global server acts as a central node of the modular system, and may have connections to each central server as well as to strategic partners such as banks, insurers and so forth.

A benefit of a global server is that all activities carried out within the modular system can be monitored at one central point, so that the status of orders or requests can be tracked, performance can be measured and compared, and various entities can be placed in contact with one another if his is required Turning to FIG. 25, a flow chart is shown, which contains steps that may be taken during the use of a system embodying the present invention, from the monitoring of physical parameters of a health-care user or patient using a biosensor to the possible treatment of the health-care user or patient and the updating of the medical records relating to the health-care user or patient.

In advantageous embodiments of the present invention, a health-care user or patient may be provided with a device which is operable to administer a selected dose of a drug or other substance to the health-care user or patient. This device may be configured to deliver the drug or other substance to the health-care user or patient at predetermined times or intervals, or alternatively a health-care expert may be able to instruct the device to deliver the drug or other substance via the computer terminal. The device may be integrated or otherwise used with a PDA of the health-care user or patient, which may control the administration and/or dosage of the drug or other substance.

It will be appreciated that the present invention provides a useful and flexible link between health-care users or patients and providers of various health-care services, which can significantly simplify the process of obtaining health-care for many individuals. The present invention is likely to benefit both health-care users or patients and health-care professionals, as well as other connected parties such as insurers.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A health-care system comprising:
processing machine;
a plurality of biosensors respectively associated with individuals, each of the biosensors being operable to gather information regarding physiological parameters of the respective individuals and relay the information to the processing machine over a network; and
data links from the processing machine to respective providers of a plurality of different health-care services to allow the transmission of instructions over the network for appropriate action to be taken in response to a determination that an individual is likely to suffer from a medical condition.

2. A system according to claim 1, further comprising a first terminal connected to the processing machine and operable to present information received from one or more of the biosensors to allow the determination of whether the individual associated with the one or more biosensors is likely to suffer from a medical condition.

3. A system according to claim 1, wherein at least some of the data links comprise links over the network.

4. A system according to claim 1, wherein the network is the Internet.

5. A system according to claim 1, wherein the network comprises a wireless network.

6. A system according claim 1, wherein the processing machine is operable to transmit instructions to at least one health-care service in response to the receipt of information indicating that at least one of the physical parameters of an individual with which one of the biosensors is associated is outside predetermined limits.

7. A system according to claim 1, further comprising a delivery device operable to administer automatically a dose of a substance to an individual.

8. A system according to claim 7, wherein the delivery device is controllable by the processing machine.

9. A system according to claim 1, further comprising a location tracking device associated with one of the individuals, to track the location of the individual.

10. A system according to claim 9, wherein instructions transmitted over the network to a health-care service include the location of an individual.

11. A system according to claim 1, further comprising a database storing medical records of at least some of the individuals.

12. A system according to claim 11, wherein the processing machine is operable to update the database following the receipt of information from one of the biosensors.

13. A system according to claim 12, wherein the processing machine is operable to present at least some of the records relating to an individual along with data received from a biosensor relating to that individual.

14. A system according to claim 1, wherein the processing machine is operable to allow real-time consultation over the network between one of the individuals and a health-care expert.

15. A system according to claim 14, wherein the processing machine is operable to allow at least one further party to join the real-time consultation.

16. A system according to claim 14, wherein the real-time consultation comprises video conferencing.

17. A system according to claim 1, wherein the individuals are selected from the group comprising: health-care users, out-patients, in-patients and intensive care patients.

18. A system according to claim 1, further comprising a personal data storage unit associated with one of the individuals.

19. A system according to claim 18, wherein the personal data storage unit is operable to receive and store data from a biosensor.

20. A system according to claim 18, wherein the personal data unit is used to identify an individual to a biosensor before the biosensor gathers the information from the individual.

21. A system according to claim 20, wherein the plurality of bionsensors are operable to gather information on selected physiological parameters in dependence upon the identity of an individual.

22. A system according to claim 18, wherein records relating to the individual are stored on the personal data storage unit.

23. A system according to claim 18, wherein the personal data storage unit allows access to a database on which medical records relating to the individual are stored.

24. A system according to claim 18, wherein the personal data storage unit is programmed to allow access to selected portions of medical records of the individual to selected entities.

25. A system according to claim 1, wherein the personal data storage unit is operable to connect to the network by a wireless connection or by a contact connection.

26. A system according to claim 18, wherein the personal data storage unit comprises a smart card.

27. A system according to claim 18, further comprising a portable processing device, wherein the personal data storage unit is operable to transfer data stored therein to the portable processing device.

28. A system according to claim 27, wherein the portable processing device is operable to analyse data received from the personal data storage unit to determine whether at least one of the physical parameters of an individual with which one of the biosensors is associated is outside predetermined limits.

29. A system according to claim 24, wherein, the access of the selected entities to the selected portions of the records expires after a predetermined period.

30. A system according to claim 1, wherein the health-care services are selected from the group comprising: a pharmacy, a physician, an emergency service; a medical hardware supplier; a nutritionist; a source of health-care information; a health-care related government body; a nursing care centre; a research facility; a health insurance broker; and a financial institution.

31. A system according to claim 1, wherein one of the health-care services comprise a source of medical records having features selected from the group comprising bio-data, health-care records, a health-care calendar, and a financial calendar.

32. A system according to claim 1, wherein the processing machine is operable to transmit information regarding a condition that an individual has or is likely to develop to the individual.

33. A system according to claim 1, wherein the information is relayed to the processing machine over the network in an encrypted form, the encryption being specific to the individual to whom the information relates.

34. A system according to claim 1, wherein an individual has an identification number and the gathered information for the individual is encrypted with the identification number into a data packet for decryption by the processing machine.

35. A system according to claim 1, wherein at least one of the biosensors comprises a microarray.

36. A system according to claim 1, wherein at least one of the biosensors is operable to obtain a DNA sample from an individual.

37. A method of monitoring the health of a plurality of individuals, the method comprising the steps of:
equipping a plurality of individuals with biosensors;
gathering information regarding physiological parameters of the respective individuals using the biosensors;
relaying the information to a processing machine over a network; and
providing data links to respective providers of a plurality of different health-care services to allow the transmission of instructions over the network for appropriate action to be taken in response to a determination that an individual is likely to suffer from a medical condition.

38. A method according to claim 37, further comprising the step of presenting the information received from one or more of the biosensors to allow the determination of whether the individual associated with the one or more biosensors is likely to suffer from a medical condition.

39. A method according to claim 37, wherein at least some of the data links comprise links over the network.

40. A method according to claim 37, wherein the network is the Internet.

41. A method according to claim 37, wherein the network comprises a wireless networks.

42. A method according claim 35, further comprising the step of transmitting instructions to at least one health-care service in response to the receipt of information indicating that at least one of the physical parameters of an individual with which one of the biosensors is associated is outside predetermined limits.

43. A method according to claim 37, further comprising the step of providing a delivery device operable to administer automatically a dose of a substance to an individual.

44. A method according to claim 43, wherein the delivery device is controllable by the processing machine.

45. A method according to claim 37, further comprising the step of tracking the location of one of the individuals using a location tracking device associated with the individual.

46. A method according to claim 45, wherein the step of transmitting instructions over the network to a health-care service includes the step of providing the location of an individual.

47. A method according to claim 37, further comprising the step of storing medical records of at least some of the individuals.

48. A method according to claim 47, wherein the processing machine is operable to update the medical records following the receipt of information from one of the biosensors.

49. A method according to claim 48, further comprising the step of presenting at least some of the records relating to an individual along with the presentation of data received from a biosensor relating to that individual.

50. A method according to claim 37, further comprising the step of allowing real-time consultation over the network between one of the individuals and a health-care expert.

51. A method according to claim 50, further comprising the step of allowing at least one further party to join the real-time consultation.

52. A method according to claim 50, wherein the step of allowing real-time consultation comprises the step of allowing video conferencing.

53. A method according to claim 37, further comprising the step of selecting the individuals from the group comprising: health-care users, out-patients, in-patients and intensive care patients.

54. A method according to claim 37, further comprising the step of providing one of the individuals with a personal data storage unit.

55. A method according to claim 37, wherein the personal data storage unit is operable to receive and store data from a biosensor.

56. A method according to claim 54, further comprising the step of identifying the individual to a biosensor, from information stored on the personal data storage unit, before the biosensor gathers the information from the individual.

57. A method according to claim 56, wherein the method comprises the step of gathering information on selected physiological parameters determined by the identity of an individual.

58. A method according to claim 54, wherein medical records relating to the individual are stored on the personal data storage unit.

59. A method according to claim 54, wherein the personal data storage unit allows access to a database on which medical records relating to the individual are stored.

60. A method according to claim 54, further comprising the step of programming the personal data storage unit to allow access to selected portions of medical records of the individual to selected entities.

61. A method according to claim 37, wherein the personal data storage unit is operable to connect to the network by a wireless connection or by a contact connection.

62. A method according to claim 54, wherein the personal data storage unit comprises a smart card.

63. A method according to claim 37, further comprising the step of providing a portable processing device, the personal data storage unit being operable to transfer data stored therein to the portable processing device.

64. A method according to claim 63, wherein the portable processing device is operable to analyse data received from the personal data storage unit to determine whether at least one of the physical parameters of an individual with which one of the biosensors is associated is outside predetermined limits.

65. A method according to claim 60, wherein the access of the selected entities to the selected portions of the records expires after a predetermined period.

66. A method according to claim 37, wherein the health-care services are selected from the group comprising: a pharmacy, a physician, an emergency service; a medical hardware supplier; a nutritionist; a source of health-care information; a health-care related government body; a nursing care centre; a research facility; a health insurance broker; and a financial institution.

67. A method according to claim 37, wherein one of the health-care services comprises a source of medical records having features selected from the group comprising bio-data, healthcare-records, a health-care calendar, and a financial calendar.

68. A method according to claim 37, further comprising the step of transmitting information regarding a condition that an individual has or is likely to develop to the individual.

69. A method according to claim 37, wherein the information is relayed to the processing machine over the network in an encrypted form, the encryption being specific to the individual to whom the information relates.

70. A method according to claim 37, wherein each individual has an identification number and the gathered information for the individual is encrypted with the identification number into a data packet for decryption by the processing machine.

71. A method according to claim 37, wherein at least one of the biosensors comprises a microarray.

72. A method according to claim 37, wherein at least one of the biosensors is operable to obtain a DNA sample from an individual.
